(19) United States
(12) Patent Application Publication
(10) Pub. No.: US 2007/0150293 A1
(43) Pub. Date: Jun. 28, 2007

(54) METHOD AND SYSTEM FOR CMMI DIAGNOSIS AND ANALYSIS

(76) Inventor: Aldo Dagnino, Cary, NC (US)

Correspondence Address: MOORE & VAN ALLEN PLLC, P.O. BOX 13706, Research Triangle Park, NC, 27709, US

(21) Appl. No.: 11/306,305

(22) Filed: Dec. 22, 2005

(51) Int. Cl. G06Q 99/00; G06F 15/02; G06F 9/46; H04M 3/51

(52) U.S. Cl. 705/1; 705/9; 705/11

(57) ABSTRACT

A method for CMMI or the like diagnosis and analysis may include generating a set of questions in response to process areas selected for diagnosis. The method may also include selecting an appropriate path sequence for further questions in response to a respondent's answers to the set questions and any further questions. The method may further include identifying any weaknesses based on responses to the set of questions and any further questions.

### BACKGROUND OF THE INVENTION

The present invention relates to Capability Maturity Model Integration (CMMI) or the like and more particularly to a method and system for CMMI diagnosis and analysis.

CMMI is a set of best practices that address the development and maintenance of products and services covering the lifecycle of a product from conception through delivery and maintenance. CMMI was developed by the Software Engineering Institute (SEI) of Carnegie Mellon University. The principles described in CMMI constitute an essential framework for the development of products. The CMMI principles constitute areas of knowledge such as software engineering, systems engineering, product integration and acquisition. By integrating these principles, CMMI provides a comprehensive framework for the development and maintenance of products and services. The intent of CMMI is to provide a capability maturity model that covers product and service development and maintenance, as well as to provide an extensible framework so that new bodies of knowledge (or disciplines) can be incorporated. In order to identify the strength and weaknesses of an organization, a diagnostic activity may be performed. The Software Engineering Institute certifies Lead Appraisers to perform CMMI SCAMPI Class A, B, and C appraisals, and they perform these appraisals with a team of appraisers. SCAMPI stands for Standard CMMI Assessment Method for Process Improvement. Computerized tools that can be used to facilitate conducting CMMI appraisals, and capturing appraisal data have been developed, such as such as Appraisal Wizard, Model Wizard, and others. However, there is no computerized CMMI diagnostic tool that “reasons” and acts like an “expert” to guide a user through the appraisal activity and identifies strengths and weaknesses of an organization and provides a set of recommendations based on past experiences to “tackle” the weaknesses uncovered. Appraisal Wizard and Model Wizard are both available from Integrated System Diagnostics of Pocasset, Mass. Appraisal Wizard and Model Wizard are trademarks of Integrated System Diagnostic in the United States, other countries or both.

### BRIEF SUMMARY OF THE INVENTION

In accordance with an embodiment of the present invention, a method for CMMI diagnosis and analysis may include generating a set of questions in response to process areas selected for diagnosis. The method may also include selecting an appropriate path sequence for further questions in response to a respondent's answers to the set questions and any further questions. The method may further include identifying any weaknesses based on responses to the set of questions and any further questions. The method may provide recommendations to convert weaknesses uncovered during the diagnostic activity into strengths by drawing from a knowledge base of past experiences. The method may also allow the user to add new experiences to the knowledge base for future use.

In accordance with another embodiment of the present invention, a system for CMMI diagnosis and analysis may include a CMMI inference engine to generate a set of questions for presentation to a respondent in response to a process area selected for diagnosis and the respondent's responses to previous questions. The system may also include a CMMI process areas knowledge base accessible by the CMMI inference engine.

In accordance with another embodiment of the present invention, a computer program product for CMMI diagnosis and analysis may include a computer usable medium having computer usable program code embodied therein. The computer usable medium may include computer usable program code configured to generate a set of questions in response to process areas selected for diagnosis. The computer usable medium may also include computer usable program code configured to select an appropriate path sequence for further questions in response to a respondent's answers to the set questions and any further questions. The computer usable medium may further include computer useable program code configured to identify any weaknesses compared to the CMMI framework based on responses to the set of questions and any further questions.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIGS. 1A-1D (collectively FIG. 1) represent flow charts associated with an example of a method for a computer-intelligent CMMI diagnosis and analysis in accordance with an embodiment of the present invention.

FIG. 2 is an example of a graphical user interface (GUI) generable by a CMMI diagnostic and analysis system for mapping an organization's terminology to CMMI terminology in accordance with an embodiment of the present invention.

FIG. 3 is an example of GUI generable by a CMMI diagnostic and analysis system for selecting Process Areas related to a CMMI diagnosis or analysis in accordance with an embodiment of the present invention.

FIG. 4 is an example of a representation of a Process Area in accordance with an embodiment of the present invention as per in the CMMI model.

FIG. 5 is an example of a GUI generable by a CMMI diagnostic and analysis system for presenting questions to a user or respondent as part of a CMMI diagnosis or analysis in accordance with an embodiment of the present invention.

FIG. 6 is an example of a report generable by a CMMI diagnostic and analysis system to present CMMI diagnosis or analysis results to a requester in accordance with an embodiment of the present invention.

FIG. 7 is a block diagram of an exemplary system for CMMI diagnosis and analysis in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention. While the present invention is described with respect to Capability Maturity Model Integration, the invention is not intended to be limited to CMMI and the principles and operations of the invention may be applicable to other similar technologies or processes.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

At present, the main disciplines that CMMI covers include: (1) systems engineering; (2) software engineering; (3) integrated product and process development; and (4) supplier sourcing. These four disciplines described in the CMMI are addressed or defined by what are referred to as “Process Areas” associated with each discipline. A Process Area may be defined as a cluster of related best practices in an area that, when implemented collectively, satisfies a set of goals considered important for making significant improvement in that Process Area. There are also two types of CMMI representations: a staged representation and a continuous representation. The staged representation uses pre-defined sets of Process Areas to define an improvement path in the development organization that is referred to as a Maturity Level. The continuous representation allows an organization to select a specific set of Process Areas and improve on them individually. The continuous representation uses Capability Levels to characterize improvements relative to an individual Process Area. CMMI is described in more detail in CMMI®: Guidelines for Process Integration and Product Improvement, by M. B. Chrissis, M. Konrad, and S. Shrum, SEI Series in Software Engineering, Addison-Wesley (2003). The computer system described applies to any extensions or changes that the CMMI framework may undergo in the future.

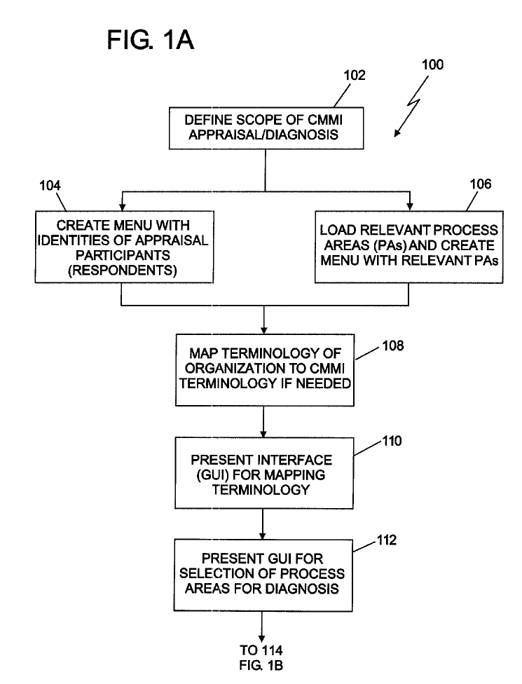

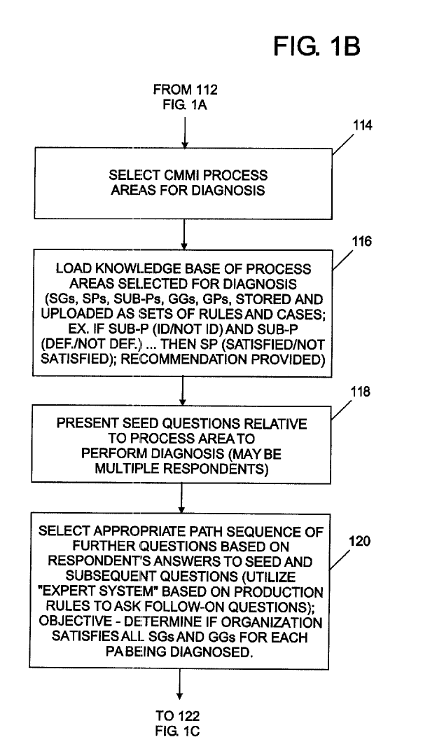

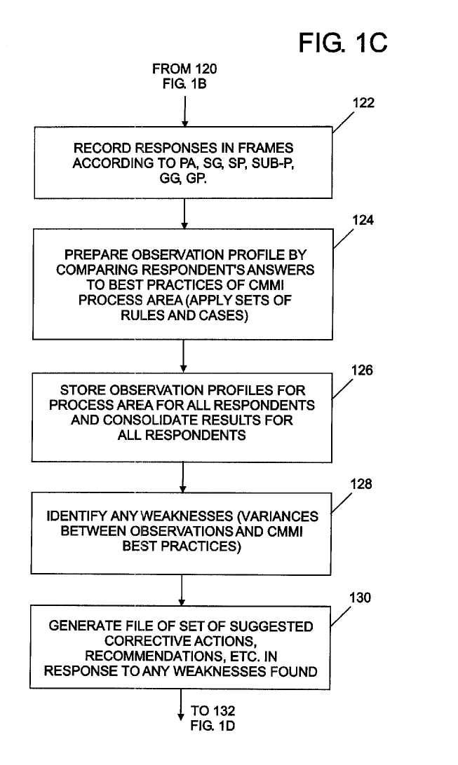

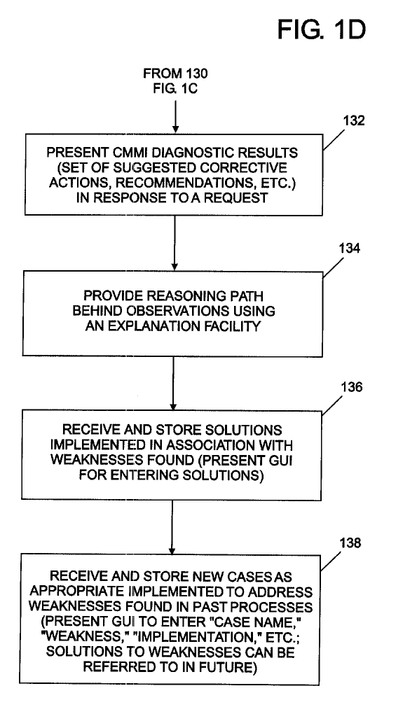

FIGS. 1A-1D (collectively FIG. 1) depict flow charts of an example of a method 100 for CMMI diagnosis and analysis in accordance with an embodiment of the present invention. In block 102, the scope of the CMMI appraisal or diagnosis may be defined. This scope may refer to the process areas to be diagnosed, the projects in the organization to be considered, and the size of the organization that will be covered. In block 104, a menu with identities of appraisal participants, respondents or the like may be created which may be part of defining the scope of the CMMI appraisal or diagnosis in block 102. In block 106, relevant Process Areas (PAs) may be loaded and a menu of relevant PAs may be created. The Process Areas loaded may be different depending upon the participants. Some Process Areas may not be associated with some participants or roles of participants.

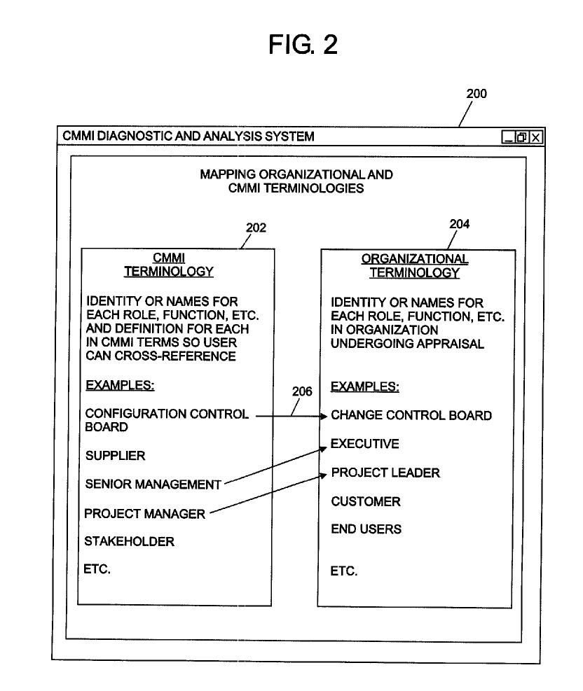

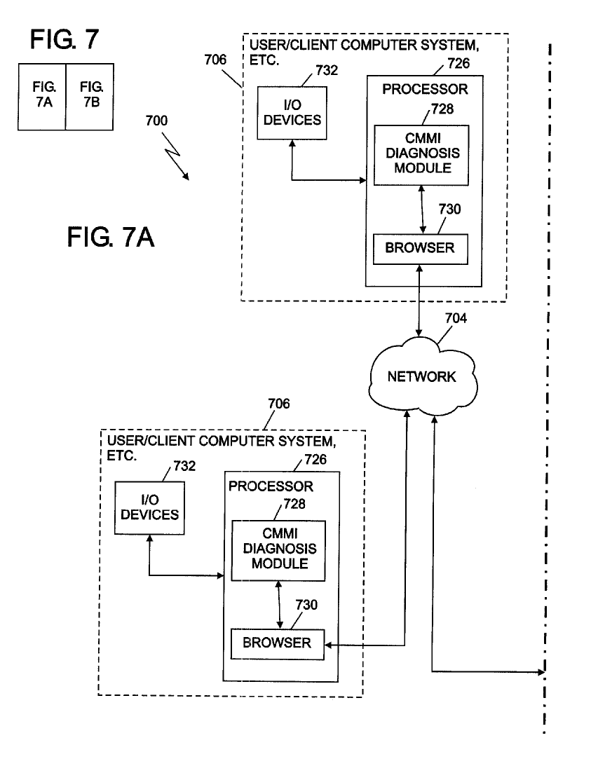

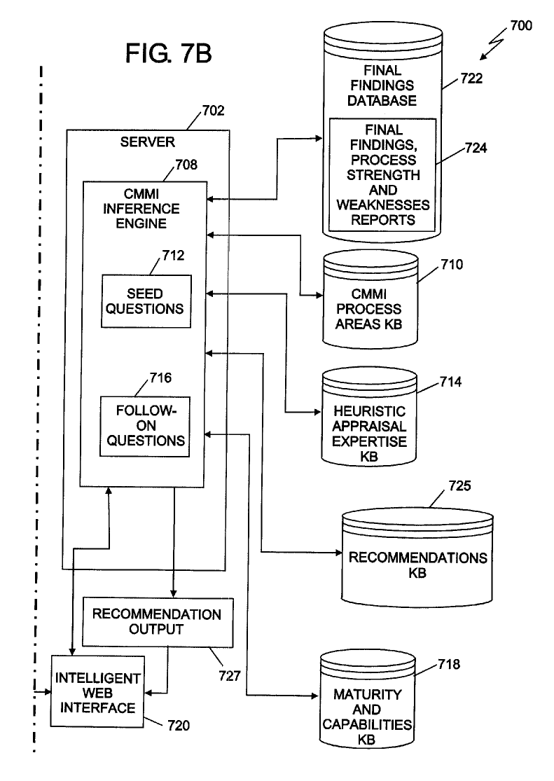

In block 108, terminology of an organization under diagnosis or analysis may be mapped to the CMMI terminology, if needed. As an example of how the mapping may be accomplished, in block 110, a GUI may be presented for a user to perform the mapping. Referring also to FIG. 2, FIG. 2 is an example of a graphical user interface (GUI) 200 generable by a CMMI Diagnostic and Analysis System, such as system 700 of FIG. 7, for mapping an organization's terminology to CMMI terminology in accordance with an embodiment of the present invention. The CMMI terminology may be listed in a column 202 that may be labeled “CMMI Terminology” or similar descriptive label and the organization's terminology may be listed in another column 204 that may be labeled “Organizational Terminology” or other appropriately descriptive label. The CMMI terminology in column 202 may include identities or names for each role, function, level of management or the like and a definition for each entry in CMMI terminology so that a user can cross-reference to related roles, functions or the like that may be listed in the organizational terminology column 204. Cross-references 206 may then be made by a user between the two columns to map the terminologies. The cross-references may be made by any suitable means, such as using a computer pointing device, voice entry or the like.

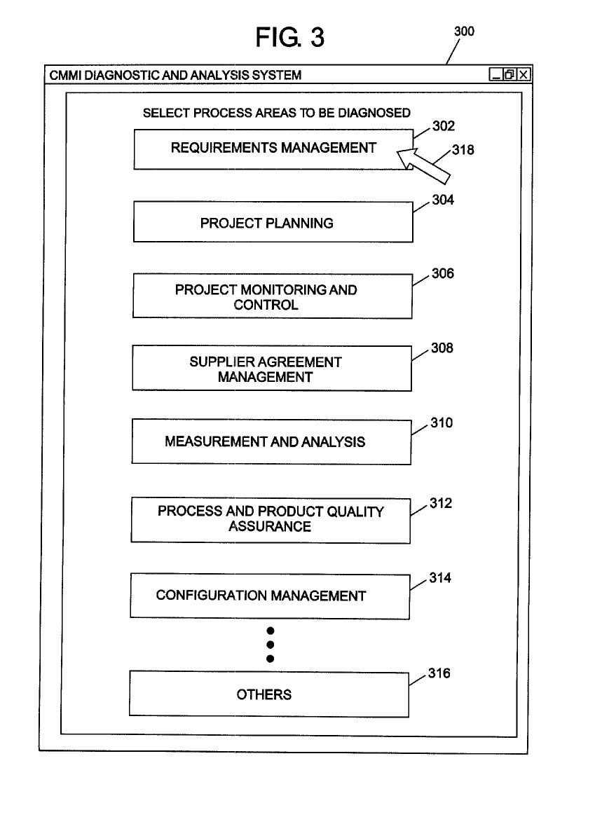

Referring to FIG. 1B, a graphical user interface (GUI) may be presented in block 112 for a user to select Process Areas to be associated with an analysis or diagnosis. Referring also to FIG. 3, FIG. 3 is an example of GUI 300 generable by a CMMI Diagnostic and Analysis System, such as system 700 (FIG. 7), for selecting Process Areas related to a CMMI diagnosis or analysis in accordance with an embodiment of the present invention. Examples of Process Areas as illustrated in FIG. 3 may include Requirements Management 302, Project Planning 304, Project Monitoring and Control 306, Supplier Agreement Management 308, Measurement and Analysis 310, Process and Product Quality Assurance 312, Configuration Management 314 or other Process Areas in the CMMI model.

Referring back to FIG. 1 B, in block 114 CMMI Process Areas may be selected for diagnosis or analysis. In the example GUI 300 in FIG. 3, a CMMI Process Area 302-316 may be selected by clicking-on the Process Area 302-316 using a computer pointing device or the like as indicated by arrow 318 or by some other means, such as voice recognition commands or the like. Any Process Areas 302-316 may be highlighted or otherwise identified to indicate that the Process Area has been selected for applicability in the diagnosis or analysis.

In block 116, a knowledge base of each Process Area selected for diagnosis may be loaded. A CMMI analysis system, such as the system 700 of FIG. 7, may store knowledge bases associated with the CMMI Process Areas (currently 25). As described in more detail herein, a Process Area knowledge base may contain a body of knowledge associated with that Process Area as a set of rules that define the practices, sub-practices, and informative materials that are needed to satisfy the CMMI goals associated with the Process Area. Accordingly, the knowledge base for a Process Area may be stored as rules, cases, or any other knowledge-based representation. By satisfying CMMI goals, an organization may demonstrate that it has established and uses industrially sound and proven practices for product development activities and the like.

As an example, considering a Project Planning Process Area, the objective of the Project Planning CMMI Process Area may be to prescribe “best” industry practices to ensure that plans that define product development project activities are properly established and maintained, as per the CMMI model. The Project Planning Process Area in CMMI may be structured as a set of Specific Goals (SGs) and Generic Goals (GGs). Specific Goals are those related specifically to the achievement of the Process Area while Generic Goals are common to all Process Areas and define the institutionalization of the processes. There may be three Specific Goals for the Project Planning Process Area: (a) establish estimates; (b) develop a project plan; (c) obtain commitment to the plan. Each Specific Goal in CMMI may be associated with Specific Practices (SPs) which need to be satisfied to satisfy the Specific Goals. Each Specific Practice may be associated with a set of sub-practices that are those guidelines or activities that are suggested to satisfy a Specific Practice. The objective of a diagnosis may be to determine whether an organization satisfies all Specific Goals and Generic Goals of a Process Area. Currently, five Generic Goals have been identified in CMMI the Software Engineering Institute (SEI) at Carnegie Mellon University may be contacted for further information regarding Specific Goals, Generic Goals, and Generic Practices for particular Process Areas associated with the CMMI model). A computerized system, such as system 700 (FIG. 7), may store all Process Areas of CMMI knowledge bases that contain Specific Goals and Generic Goals, practices, sub-practices, and informative materials for each Process Area. For the purposes of illustrating how a knowledge base for a Process Area may be stored in a system, consider the SP 1.1-1 of the SG 1 for the Project Planning Process Area according to the CMMI model:

| | |
|---|---|
| Specific Goal 1: | Establish Estimates |
| Specific Practice 1.2-1: | Estimate the scope of the project |
| Sub-practice 1: | Develop a work breakdown structure based on |
| | the product architecture |
| Sub-practice 2: | Identify work packages to specify estimates |
| Sub-practice 3: | Identify work products that will be acquired |
| | externally |
| Sub-practice 4: | Identify work products that will be reused |

A system, such as system 700 (FIG. 7), may store the knowledge base as a set of rules and cases. When the user selects the Process Areas to be part of the scope of a diagnosis, the system loads these knowledge bases, which are represented as rules and cases similar to that illustrated:

Rules SG 1 SP 1.1-1

Rule SG 1 SP 1.1-1 Satisfied
If

(a work breakdown structure is DEFINED) and
(work packages to for estimation purposes are IDENTIFIED) and
(products acquired externally are IDENTIFIED) and
(reused work products are IDENTIFIED)

Then

(Specific Practice 1.2-1 is SATISFIED)

Rule SG 1 SP 1.1-1 Not Satisfied 1
If

(a work breakdown structure is NOT DEFINED) and
(work packages to for estimation purposes are IDENTIFIED) and
(products acquired externally are IDENTIFIED) and
(reused work products are IDENTIFIED)

Then

(Specific Practice 1.2-1 is NOT SATISFIED)
(Recommendation is “define work breakdown structure”)

Rule SG 1 SP 1.1-1 Not Satisfied 2
If

(a work breakdown structure is DEFINED) and
(work packages to for estimation purposes are NOT IDENTIFIED)
and (products acquired externally are IDENTIFIED) and
(reused work products are IDENTIFIED)

Then

(Specific Practice 1.2-1 is NOT SATISFIED)
(Recommendation is “identify work packages for estimation

purposes”)
Rule SG 1 SP 1.1-1 Not Satisfied 3
If

(a work breakdown structure is DEFINED) and
(work packages to for estimation purposes are IDENTIFIED) and
(products acquired externally are NOT IDENTIFIED) and
(reused work products are IDENTIFIED)

Then

(Specific Practice 1.2-1 is NOT SATISFIED)
(Recommendation is “identify work products to be acquired

externally”)
Rule SG 1 SP 1.1-1 Not Satisfied 2
If

(a work breakdown structure is DEFINED) and
(work packages to for estimation purposes are IDENTIFIED) and
(products acquired externally are IDENTIFIED) and
(reused work products are NOT IDENTIFIED)

Then

(Specific Practice 1.2-1 is NOT SATISFIED)
(Recommendation is “identify work products to be reused”)

A Case may determine possible alternative ways of how to implement the sub-practices. The knowledge base of cases has the potential of growing as more experiences are accumulated from performing diagnostics on how organizations implement sub-practices. An example of a case may be:

Case SG 1 SP 1.2-1

| | |
|---|---|
| Work breakdown | Cluster of tasks required to develop work products |
| structure: | High-level activities required to develop work products |
| Work packages: | Definition of roles and responsibilities in project |
| | Lower-level work breakdown structure |

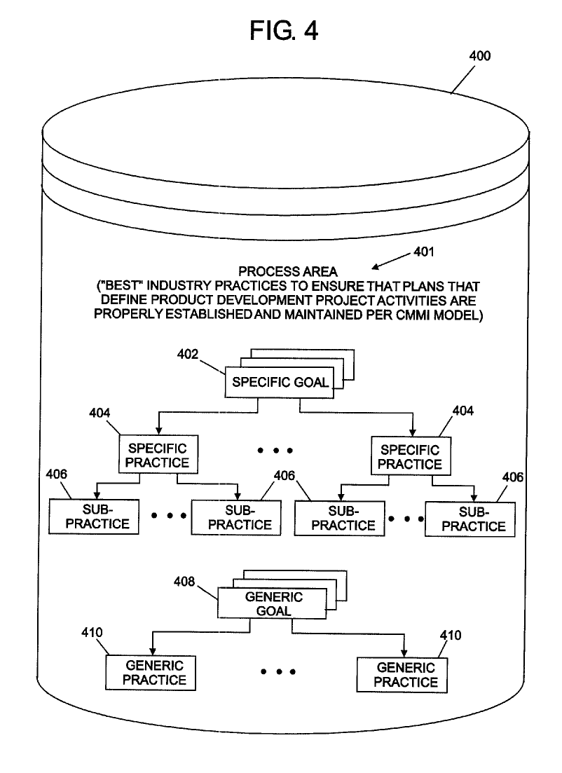

Referring also to FIG. 4, FIG. 4 is an example of a representation of a knowledge base 400 of a Process Area 401 in accordance with an embodiment of the present invention. The knowledge base of the Process Area 401 may include specific goals 402 (SGs), specific practices 404 (SPs), and sub-practices 406 (SUB-Ps) as previously discussed. There may be a plurality of sub-practices 406 that define a specific practice 404 and there may be a plurality of specific practices 404 that define a specific goal 402. Accordingly, each of the specific practices 404 associated with a particular specific goal 402 must be identified or satisfied for the specific goal 402 to be completely satisfied. Sub-practices 406 are informative materials or implementation guidelines in the CMMI framework.

As previously discussed, the knowledge base 400 may also include generic goals 408 (GGs) and generic practices 410 (GPs). A plurality of generic practices 410 may be associated with each generic goal 408. To completely satisfy a generic goal 408 , each of the associated generic practices 410 must be satisfied.

Accordingly, the knowledge base, SGs, SPs, SUB-Ps, GGs and GPs may be stored and uploaded to a system, such as system 700 in FIG. 7 or the like, as sets of rules, cases or any other knowledge-based representation. Each a rule or case may be a conditional expression, e.g., “If sub-practice A identified or not identified and sub-practice B identified or not identified . . . , then specific practice C is either satisfied or not satisfied.

In block 118 , seed questions may be presented relative to the Process Areas selected to perform the diagnosis. The seed questions may be presented to multiple respondents who are participating in the diagnosis or analysis. The seed questions will be related to the Process Area and may be directed to determine whether the sub-practices and specific practices are identified or satisfied. For the example previously discussed, a seed question or group of seed question may be formulated to elicit a work breakdown structure based on a product's architecture. Another example of a seed question or group of seed questions may be to identify work products that will be acquired externally or work products that will be reused or similar types of questions.

In block 120 , an appropriate path sequence of further questions based on a respondent's answer to seed questions and subsequent questions may be selected. The system may utilize an “expert system” based on production rules to ask follow-on questions. Expert systems are commercially available systems and they are based primarily on production rules. The objective with respect to the seed questions and subsequent questions is to determine if an organization being analyzed or diagnosed satisfies all of the specific goals and generic goals for each Process Area being diagnosed.

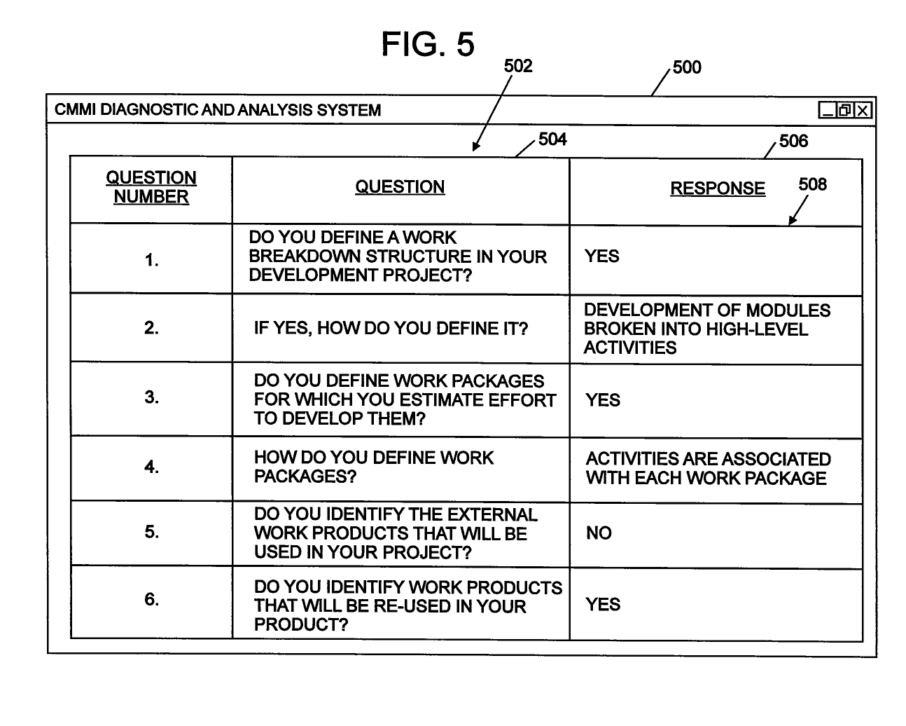

Referring also to FIG. 5, FIG. 5 is an example of a GUI 500 generable by a CMMI diagnostic and analysis system for presenting questions 502 for a user or respondent to answer as part of a CMMI diagnosis or analysis in accordance with an embodiment of the present invention. The GUI 500 may include one column 504 of fields for the questions and another column 506 of fields for the respondent to enter responses. Examples of questions 502 and possible responses 508 are illustrated in FIG. 5. The questions may be seed questions or subsequent follow-on questions generated by the expert system.

Referring back to FIG. 1, in block 122, responses to the seed questions and subsequent questions may be recorded in frames by the CMMI system according to the Process Area, specific goal, specific practice, sub-practice, generic goal and generic practice. An example of recording the responses is illustrated in the following table:

Project Planning Process Area

| | |
|---|---|
| Specific Goal 1: | Establish Estimates |
| Specific Practice 1.2-1: | Estimate the scope of the project |
| Sub-practice 1 Develop work | DEFINED |
| breakdown structure: | |
| Sub-practice 1 WBS defined as: | development of modules broken into |
| | high-level activities |
| Sub-practice 2 Work packages: | IDENTIFIED |
| Sub-practice 2 Work packages | Activities are associated with each |
| definition: | work package |
| Sub-practice 3 External work | NOT IDENTIFIED |
| products: | |
| Sub-practice 4 Reused work | IDENTIFIED |
| products: | |

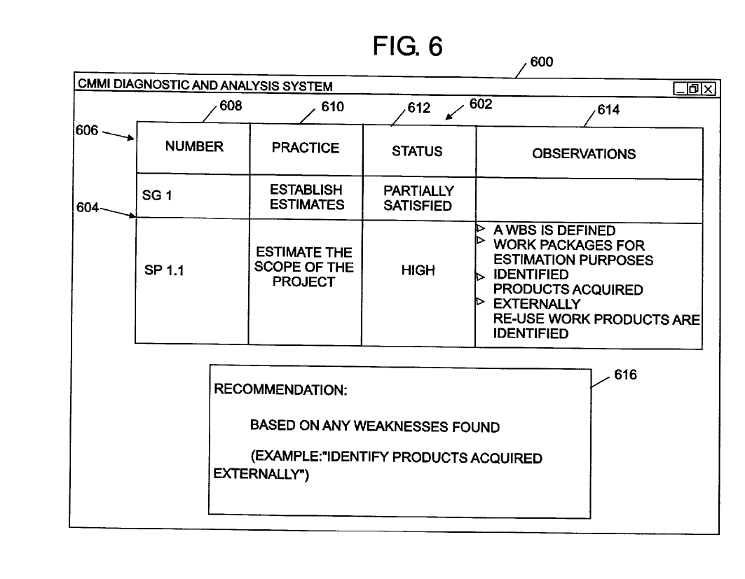

In block 124 , an observation profile may be prepared by comparing a respondent's answers to best practices for the CMMI Process Area or Process Areas involved in the analysis or diagnosis. The observation profile may be determined by applying the sets of rules and cases. The observation profile may include information similar to that illustrated in the table 604 of FIG. 6 and described below with reference to FIG. 6. In block 126, observation profiles for each Process Area for all respondents may be stored. The results for all respondents may be consolidated.

In block 128, any weaknesses may be identified. Weaknesses may be identified as any variances between observations and CMMI best practices. In block 130, a file of a set of suggested corrective actions, recommendations or the like may be generated in response to any weaknesses found. The system will compare a weakness identified with its database of “cases”, which contain recommendations associated with weaknesses. The system will provide corrective actions from this “cases” database. The system allows for the storage of new corrective actions associated with a weakness so that new solutions to weaknesses can be proposed in the future whenever the weakness may re-appear.

In block 132, the CMMI diagnostic results may be presented in response to a request for the results. Referring also to FIGS. 6, FIG. 6 is an example of a GUI 600 for presenting a report 602 generable by a CMMI diagnostic and analysis system to present CMMI diagnosis or analysis results to a user or requester in accordance with an embodiment of the present invention. The CMMI diagnostic report 602 may include a table 604 with a plurality of columns 606. The columns may be labeled “Number,” “Practice,” “Status,” “Observations” or similar labels to describe the information contained in each column. The “Number” column 608 may indicate in each row the Specific Goal (SG), Specific Practice (SP), Sub-Practice (SUB-P), Generic Goal (GG), Generic Practice (GP) or the like by an identity number according to the CMMI model. The “Practice” column 610 may indicate in each row a description of SG, SP, SUB-P, GG, GP, etc. identified in the “Number” column 608. The “Status” column 612 may indicate in each row a status of the associated SG, SP, SUB-P, GG, GP, etc. in the “Number” column 608 and the “Observation” column 614 may indicate an observation or remark in each row associated with the SG, SP, SUB-P, GG, GP, etc. in the “Number” column 608. The observations may result from the respondent's answers to the seed questions and subsequent follow-on questions. The report 602 may also include a corrective action or recommendation 616 or a set of suggested corrective actions, recommendations or the like associated with a CMMI diagnosis or analysis. The recommendation 616 or corrective actions may be based on any weaknesses or other anomalies found during the CMMI diagnosis or analysis.

Referring back to FIG. 1C, in block 134 , a reasoning path behind the observations may be provided using an explanation facility. The user may be able to observe the reasoning path for each observation by clicking on the explanation facility capability of the system. The reasoning path may be the rule or rules, previously discussed, that the system followed to arrive at the conclusions or results of the diagnosis. From the example previously described the reasoning path or rule may be:

Rule SG 1 SP 1.1 -1 Not Satisfied 2

If

(a work breakdown structure is DEFINED) and
(work packages to for estimation purposes are IDENTIFIED) and
(products acquired externally are NOT IDENTIFIED) and
(reused work products are IDENTIFIED)

Then

(Specific Practice 1.2-1 is NOT SATISFIED)
(Recommendation is “identify work products to be acquired
externally”)

Accordingly, the explanation facility of the system may simply use the rule(s) that was triggered based on the responses from the user. Based on the example above, the reasoning path identifies that the organization defines a work breakdown structure; identifies work packages to be used for estimation purposes; does not identify products acquired externally; and identifies work products to be reused in the development activity. The preceding defines the path of reasoning and therefore, the explanation facility on how the conclusions or observations were derived.

In block 136 , solutions implemented to overcome the weaknesses found may be received and stored. A GUI (not shown in the Figures) may be presented for a user to enter the solutions. In block 138 , new cases may be received and stored as appropriate to address weaknesses found in past processes. Another GUI (not shown in the Figures) may be presented to a user to enter the new cases. The GUI may include fields for entering a “Case Name,” a “Weakness” associated with the case, an “Implementation” to overcome the weakness and any other fields that may be deemed appropriate for tracking or monitoring the solutions or cases. By maintaining a record of the solutions and monitoring the solutions, the present invention permits the solutions to different weaknesses to be referenced in the future. As solutions to weaknesses are stored in a cases knowledge base, the knowledge base becomes richer and can be accessed in the future to refer to solutions to weaknesses found in other organizations.

FIG. 7 is a block diagram of an exemplary system 700 for CMMI diagnosis and analysis in accordance with an embodiment of the present invention. The method 100 in FIG. 1 may be embodied in and performed by the system 700. The system 700 may include a server 702 that may be accessed via network 704 by multiple users, client computer systems 706 or the like. The network 704 may be the Internet or a private network, such as an intranet or the like. The network 704 may be accessed via a wireless connection, wired connection or combination thereof.

A CMMI inference engine 708 may be operable on the server 702. Elements or functions similar to those described with respect to method 100 in FIG. 1 may be embodied in or performed by the CMMI inference engine 708. A CMMI Process Areas knowledge base (KB) 710 may be accessible by the CMMI inference engine 708. The CMMI Process Areas KB 710 may contain knowledge associated with the Process Areas of the CMMI. Accordingly, the CMMI Process Areas KB 710 may include information related to required components, expected components, and informative components of each CMMI Process Area. In CMMI, “Required Components” describe what an organization must achieve to satisfy a process area. This achievement must be visibly implemented in an organization's processes. The required components in CMMI are the specific and generic goals. Goal satisfaction is used in appraisals as the basis for deciding if a process area has been achieved and satisfied. Expected components describe what an organization will typically implement to achieve a required component. Expected components guide those who implement improvements or perform appraisals. Expected components include the specific and generic practices. Before goals can be considered satisfied, either the practices as described or acceptable alternatives to them are present in the planned and implemented process of the organization. Informative components provide details that help organizations get started in thinking about how to approach the required and expected components” (Chrissis, M. B., Konrad, M., and Shrum, S. (2003) “CMMI: Guidelines for Process Integration and Product Improvement”, the SEI Series in Software Engineering editors. Hence, this knowledge base contains the knowledge of the basic CMMI framework. Through the CMMI Process Areas KB 710 , initial seed questions 712 may be generated by the inference engine 710 for presentation to a user, or a plurality of users or respondents. The initial seed questions 712 may be associated with the practices of each Process Area being diagnosed or analyzed.

A Heuristic Appraisal Expertise KB 714 may also be accessed by the inference engine 708. The Heuristic Appraisal Expertise KB 714 may contain heuristic knowledge of appraiser human experts that may help in the formulation of the subsequent or follow-on questions 716 that the system may asks the respondent or respondents after the initial seed questions 712 have been presented and responded to by the respondent or respondents or users. Based on the role and profile of the respondents there may be sets of Process Areas and questions that may be relevant to them. For example, if diagnostic activity is focused on members of a development organization answering questions, depending on the roles of the members, certain Process Areas will not apply while others will be relevant. In such cases, the Heuristic Appraisal Expertise KB 714 may guide the system 700 in identifying which Process Areas may be applicable. The questions for both the CMMI Process Areas KB 710 and the Heuristic Appraisal Expertise KB 714 may be organized according to the Process Areas and the questions may be triggered or generated based on the previous responses from the user or users.

The system 700 may also include a Maturity and Capability Levels KB 718 that may also be accessed by the CMMI inference engine 708. The Maturity and Capability Levels KB 718 may contain knowledge or information relative to the structure of both the Staged Representation of CMMI as well as the Continuous Representation of CMMI. The Maturity and Capability Levels KB 718 may contain knowledge relative to the structure of the Staged Representation and the clustering of Process Areas for each maturity level. The Maturity and Capability Levels KB 718 may also contain knowledge about the structure of the Continuous Representation of CMMI, the capability levels of each Process Area, and the relationships among the different Process Areas.

The inference engine 708 may communicate with each user computer system 706 via an intelligent web interface 720 and accesses the knowledge bases, as previously described, to generate questions to be presented to and answered by the user(s). As the user(s) provide responses to the questions 712 and 716 posed, the inference engine 708 may analyze these responses to begin discovering observations and to trigger or generate additional new questions for the users to respond to. As the appraisal progresses, the inference engine 708 may move systematically from one Process Area to the next Process Area depending on the scope of the diagnosis or analysis.

The inference engine 708 may also store the analyses in a Final Findings Database 722. The Final Findings Database 722 may provide the final output or results of the analysis or diagnosis for the user. The results may be stored in a Final Findings Process Strengths and Weaknesses Report 724, once the diagnosis has been completed. The Final Finding Process Strengths and Weaknesses Report 724 may be similar to the report 600 of FIG. 6. The Intelligent Web Interface 720 allows the user(s) and the system to communicate with each other.

The system 700 may also include recommendations knowledge base 725 that may include recommendations to solve weaknesses found based on previous solutions or experiences. The inference engine 708 may formulate a recommendation output 727 based on data in the final findings database 722, including strengths and weaknesses, and recommendations applied to solve weaknesses found in previous analyses or diagnoses. Accordingly, the system 700 is able to learn or take advantage of previous experiences.

The Intelligent Web Interface 720 may provide a customized view to the user depending on the user profile, which could be a lead appraiser, an engineering process group member, or anyone from the development organization responding the questions. The user(s) can access the system 700 via the network 704 using the intelligent web interface 720. The intelligent web interface 720 in association with the inference engine 708 may also generate GUIs similar to those described with respect to FIGS. 2, 3, 5 and 6 to facilitate conducting a CMMI diagnosis or analysis in accordance with the present invention.

Each user or client computer system 706 may include a processor 726. A CMMI diagnosis module 728 may be operable on the processor 726. The CMMI diagnosis module 728 may operate in association with the interference engine 708 under control of a user to facilitate conducting a CMMI diagnosis or analysis. A browser 730 may also be operable on the processor 726 to permit access to the intelligent web interface 720 via the network 704.

Each user or client computer system 706 may also include multiple input devices, output devices or combination input/output device represented as I/O devices 732 in FIG. 7. The I/O devices 732 may permit a user to operate and interface with the computer system 706 and to control operation of the computer system 706 and to facilitate performing CMMI diagnoses and analyses as well as running other applications or performing other operations. The I/O devices 732 may permit GUIs associated with a CMMI diagnosis or analysis to be presented to the user and to permit the user to control the CMMI analysis. The I/O devices 732 may include a keyboard, keypad, pointing device, mouse or the like. The I/O devices 732 may also include disk drives, optical, mechanical, magnetic, or infrared input/output devices, modems or the like. The I/O devices 732 may be used to access a medium. The medium may contain, store, communicate or transport computer-readable or computer useable instructions or other information for use by or in connection with a system, such as the user computer system 706 or system 700.

It should be noted that only Lead Appraisers authorized by the Software Engineering Institute are permitted to grant an official Maturity or Capability Level to an organization. Accordingly, the present invention may not be used to assign a CMMI Maturity or Capability Level to a diagnosed organization.

In summary, the present invention facilitates the collection of information about an organization, such as a development organization or other type organization, and increases the accuracy of the organizations analysis using CMMI as a framework. The invention facilitates performance of a CMMI self-diagnostic and reduces the analysis time. An important aspect of the invention may be its capability to provide a means to access knowledge associated with lead appraisers, the CMMI model itself, and proven solutions to strengthen weaknesses found in the diagnostic. The case-based reasoning capability of the tool allows addition to the solution cases space and therefore improves the quality of the recommendations. This aspect provides a “learning” capability that could be enhanced with advances in “machine learning” technology. Lead appraisers can use the method and system of the present invention to rapidly gather and analyze information and develop a quick and accurate profile of the organization being appraised. As discussed above, the present invention provides a computerized knowledge base for CMMI and an extensible computerized diagnostic tool that generates strengths and weaknesses for CMMI Process Areas. The present invention also permits remote access to the diagnostic tool via a network, such as the Internet or the like. The present invention further provides an extensible computerized knowledge base that includes experiences of CMMI appraisers.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for CMMI diagnosis and analysis, comprising:
generating a set of questions in response to process areas selected for diagnosis;
selecting an appropriate path sequence for further questions in response to a respondent's answers to the set questions and any further questions; and
identifying any weaknesses based on responses to the set of questions and any further questions.

2. The method of claim 1, further comprising comparing the respondent's answers to the set of questions and any further questions to a group of best practices of a CMMI process area.

3. The method of claim 1, further comprising preparing an observation profile in response to comparing a respondent's answers to a group of best practices of a CMMI process area.

4. The method of claim 3, further comprising providing a reasoning path behind the observation profile.

5. The method of claim 3, wherein identifying any weaknesses comprises identifying any variances between the observation profile and the group of best practices.

6. The method of claim 1, further comprising generating a set of suggested corrective actions in response to any weaknesses found.

7. The method of claim 6, further comprising presenting the CMMI diagnostic results and the set of suggested corrective actions.

8. The method of claim 1, presenting a graphical user interface to receive implemented solutions or recommendations for improvement in association with weaknesses.

9. The method of claim 8, further comprising storing implemented solutions and associated weaknesses as a new case for future reference.

10. The method of claim 1, further comprising recording responses in frames according to at least one of a group including a process area, a specific goal, a specific practice, a sub-practice, a generic goal, and a generic practice.

11. The method of claim 1, further comprising presenting a graphical user interface for selection of at least one process area to be diagnosed.

12. The method of clam 11 , further comprising loading a knowledge base of each process area selected for diagnosis.

13. The method of claim 12, wherein loading the knowledge base for each process area comprises loading a set of rules.

14. The method of claim 13, further comprising determining whether a specific practice is satisfied based on a status of at least one sub-practice.

15. The method of claim 13, wherein identifying any weaknesses comprises applying the set of rules to the respondent's answers.

16. The method of claim 1, further comprising creating a menu including identities of a plurality of respondents to answer the set of questions and any further questions.

17. The method of claim 16, further comprising consolidating responses to the set of questions and any further questions for each of the plurality of respondents.

18. The method of claim 1, further comprising mapping a terminology of an organization to be appraised to a CMMI terminology.

19. A system for CMMI diagnosis and analysis, comprising:
a CMMI inference engine to generate a set of questions for presentation to a respondent in response to a process area selected for diagnosis and the respondent's responses to previous questions; and
a CMMI process areas database accessible by the CMMI inference engine.

20. The system of claim 19, wherein the CMMI process areas database comprises information for each process area, wherein the information comprises required components, expected components and informative components.

21. The system of claim 19, wherein the CMMI process areas database comprises information for use in generating initial seed questions for presentation to the respondent.

22. The system of claim 19, further comprising a heuristic appraisal expertise database accessible by the CMMI inference engine.

23. The system of claim 22, wherein the heuristic appraisal expertise database comprises heuristic knowledge to facilitate formation of questions for presentation to the respondent after a set of seed questions.

24. The system of claim 22, wherein the CMMI process areas database and the heuristic appraisal expertise database are organized by process area and are accessed based on responses to the questions by the respondent.

25. The system of claim 19, further comprising a maturity and capability levels database accessible by the CMMI inference engine.

26. The system of claim 25, wherein the maturity and capability levels database comprises knowledge relative to a structure of a staged representation of CMMI and a clustering of process areas for each maturity level of CMMI.

27. The system of claim 26, wherein the maturity and capability levels database further comprises knowledge relative to the structure of the continuous representation of CMMI, the capability levels of each process area and the relationships between the process areas.

28. The system of claim 19, further comprising an intelligent web interface, and wherein the CMMI inference engine comprises:
means to communication with a respondent via the intelligent web interface;
means to access a plurality of knowledge databases to generate the questions for presentation to the respondent;
means to analyze responses, form observations and trigger new questions for presentation to the respondent;
means to move systematically from one process area to a next process area depending upon a scope of the diagnosis.

29. The system of claim 28, further comprising a final findings database to store a final findings process strengths and weaknesses report.

30. A computer program product for CMMI diagnosis and analysis, the computer program product comprising:
a computer usable medium having computer usable program code embodied therein, the computer usable medium comprising:
computer usable program code configured to generate a set of questions in response to process areas selected for diagnosis;
computer usable program code configured to select an appropriate path sequence for further questions in response to a respondent's answers to the set questions and any further questions; and
computer usable program code configured to identify any weaknesses based on responses to the set of questions and any further questions.

31. The computer program product of claim 30, further comprising computer usable program code configured to compare the respondent's answers to the set of questions and any further questions to a group of best practices of a CMMI process area.

32. The computer program product of claim 30, further comprising computer usable program code configured to prepare an observation profile in response to comparing a respondent's answers to a group of best practices of a CMMI process area.

33. The computer program product of claim 32, further comprising computer usable program code configured to identify any variances between the observation profile and the group of best practices.

34. The computer program product of claim 30, further comprising computer usable program code configured to generate a set of suggested corrective actions in response to any weaknesses found.

35. The computer program product of claim 30, further comprising computer usable program code configured to present the CMMI diagnostic results and the set of suggested corrective actions.

36. The computer program product of claim 30, further comprising computer usable program code configured to present a graphical user interface to receive implemented solutions in association with weaknesses.

37. The computer program product of claim 30, further comprising computer usable program code configured to record responses to questions in frames according to at least one of a group including a process area, a specific goal, a specific practice, a sub-practice, a generic goal, and a generic practice.

38. The computer program product of claim 30, further comprising computer usable program code configured to load a knowledge base for each process area selected for diagnosis.

39. The computer program product of claim 38, wherein the computer usable program code configured to load the knowledge base for each process area comprises computer usable program code configured to load a set of rules.

40. The computer program product of claim 39, further comprising computer usable program code configured to apply the set of rules to the respondent's answers to the questions to identify any weaknesses.

41. The computer program product of claim 30, further comprising computer usable program code configured to map terminology of an organization to be analyzed or diagnosed to a CMMI terminology.
